(19) United States
(12) Patent Application Publication
(10) Pub. No.: US 2011/0037191 A1
(43) Pub. Date: Feb. 17, 2011

(54) Method and Arrangement to Produce a Wind-Turbine-Blade

(76) Inventor: Henrik Stiesdal, Odense C (DK)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 12/850,715

(22) Filed: Aug. 5, 2010

(30) Foreign Application Priority Data
Aug. 13, 2009 (EP) 09010466.2

(51) Int. Cl. B29C 43/56

(52) U.S. Cl. 264/102

(57) ABSTRACT

A method and arrangement to produce a wind-turbine-blade are disclosed. A bottom layer is laid down into a forming tool. The bottom layer is used as a base of a pile. A predefined number of additional layers is stacked vertically on top of the basis to form the pile, while the pile is used as a separate module for the production of the blade. The bottom layer is made of a nearly airtight material, to prevent that surrounding air is allowed to flow vertically through the pile. An extraction of air is applied by a machine to a topmost layer of the pile in a way that the pile is sucked towards the machine. This allows to lift up the pile and to bring it into a mould for the further production of the blade.

### CROSS REFERENCE TO RELATED APPLICATIONS

This application claims priority of European Patent Office application No. 09010466.2 EP filed Aug. 13, 2009, which is incorporated by reference herein in its entirety.

### FIELD OF INVENTION

The invention relates to a method and arrangement to produce a wind-turbine-blade.

### BACKGROUND OF INVENTION

Wind turbine blades are usually made using a matrix of fiber glass mats. The building up of the matrix is characterized by a considerably amount of manual layup work where fiber mats with fibers of different orientation are put on top of each other in order to build up the strength and stiffness of the blade. The manual layup work is difficult and time-expensive.

### SUMMARY OF INVENTION

It is known to use fiber reinforced laminates, balsa-wood and fiber-mats to build up a blade in a sandwich-design. A lower mould is used to carry various sheets of the laminates, fiber-mats and of balsa-wood to form a 3D-blade-structure.

If the blade structure is completed an upper mould may be placed on top of the structure. It is connected with the lower mould to enclose the whole structure. By help of a VARTM-process a resin or any other suitable liquid thermoplastic is injected into the moulds to complete the blade.

The fiber-mats are used as fiber reinforcements of the structure and may comprise for example chop stand or woven fabric mats, multi-axis interlaid scrims, warp-thread reinforced unidirectional performs, single or joined roving bundles. They may consist of any known material, such as glass, Kevlar, carbon or even hemp.

At certain positions of the blade there is the need to pile up a number of fiber-mats one upon the other to improve the blade-structure there for stability purposes. This is done manually and mainly by hand, so a lot of time is needed to stack the fiber-mats.

The structural characteristics of a fiber reinforced laminate are usually governed by the amount, type and orientation of the reinforcement fibers. Typically, the stiffness and strength of fibers can only be taken into account to the extent that loading occurs in the longitudinal fiber direction.

Therefore a traditionally design assumes that the fibers of the finished laminate will be oriented in the same direction as the direction of the fibers when placed in a forming tool. The forming tool might be a mould for a wind turbine blade. The mould might be used later within a “vacuum assisted resin transfer method”, VARTM, to manufacture the blade.

However in many cases wrinkles in the fiber layers may occur. This results from the manufacturing process and the characteristics of the fiber mats and the used fabrics.

Wrinkles are developed because of the manual layup work and due to the woven characteristics or the interconnection of the fibers in the non woven fabrics. Highly skilled and experienced layup workers are therefore needed to prevent wrinkles during the difficult layup work.

Wrinkles leads to the fact that the fibers do not show the desired alignment or orientation, they show a more or less bended shape. The wrinkles stay inside the structure and are fixed by the infused resin of the VARTM later.

The wrinkles are weakening the whole structure, a severe overload of the laminate or the whole structure may be the result. The wrinkles result in a loss of stiffness and/or in a loss of the strength of the produced structure. This loss will often exceed any realistic safety margins of the structure.

If the wrinkles are positioned nearby the surface of the produced structure it might be possible to repair them. This needs to be done by hand in a time-expensive work.

Otherwise the whole structure needs to be rejected, which is a significant loss of money and time.

It is therefore the aim of the invention, to provide an improved method to produce a wind-turbine-blade quick and in a high quality in regard to wrinkles. It is also an aim of the invention to provide an arrangement, used within this inventive method.

These aims are solved by the features of the independents claims.

Improved embodiments of the invention are object of the dependant claims.

According to the inventive method to produce a wind-turbine-blade a bottom layer is laid down into a forming tool. The bottom layer is used as a basis of a pile. A predefined number of additional layers is stacked vertically on top of the basis to form the pile, while the pile is used as a separate module for the production of the blade. The bottom layer is made of a nearly airtight material, to prevent that surrounding air is allowed to flow vertically through the pile. An extraction of air is applied by a machine to a topmost layer of the pile in a way that the pile is sucked towards the machine. This allows to lift up the pile and to bring it into a mould for the further production of the blade.

The mould may be used later within a VART-process as described above to manufacture the blade.

The module contains in a most simple embodiment only a single layer of fiber material and the bottom layer as basis. By use of a technical vacuum the module can be lifted and can be positioned into the mould or into another carrier for the further use.

It is also possible to combine the single layer and the basis—for example a single layer of fiber material, which is made by a pre-impregnated material showing a nearly airtight characteristic.

The invention allows to speed up the blade-production process as prepared piles can be brought as components inside the mould for a wind turbine blade. This also allows to produce the components or modules of the blade in advance. So production time can be reduced, as the expensive blade-moulds can be used quicker and in a more effective manner.

The inventive method also reduces the amount of manual layup work, where large and heavy fiber-mats need to be laid up and positioned to the forming tool. Now it is now possible to layup at a position one or more bundles of layers at once by using the vacuum lifting. This way, the invention improves the working conditions for the layup workers.

The invention improves the quality of the layup work as it is now possible to use a machine to lift and position layers of fibers precisely. So wrinkles can be avoided. This results in a stronger and more consistent blade structure.

The forming tool can be a mould or in its simplest form a lay-up table or a bench.

The forming tool can be designed for a suction side or for a pressure side of the blade of the wind turbine.

The forming tool comprises the completed layers for the blade structure. In a preferred embodiment the production setup is located within the operating radius of the vacuum lifting machine used according to the invention.

In a further embodiment the forming tool is arranged for building up a part of a wind turbine blade, where a carrier is positioned at the bottom of the forming tool.

At least one layer of unconnected unidirectional roving-bundles of a fiber-material are laid-out on top of the carrier. The roving-bundles are laid out in longitudinal, axial or another predetermined direction.

The invention allows to transport and to move the stacked roving-bundles together with the carrier into a mould, which is used to build-up the blade in a sandwich-assembly.

This a great advantage compared to prior art where single roving bundles hasn't been used in the blade production due to the fact that it is not possible to handle them in a manual layup production.

Furthermore, by using layers of unconnected single roving bundles in the building of the blade it is possible to avoid wrinkles in the layers. This is a big advantage compared to prior art where layers of woven fabrics are used in the manual layup where wrinkles are likely to be formed.

### BRIEF DESCRIPTION OF THE DRAWINGS

The invention is described in more detail now by help of a figure.

FIG. 1 shows a blade, which is manufactured according to the invention, while

FIG. 2 and FIG. 3 show piles according to the invention in more detail.

### DETAILED DESCRIPTION OF INVENTION

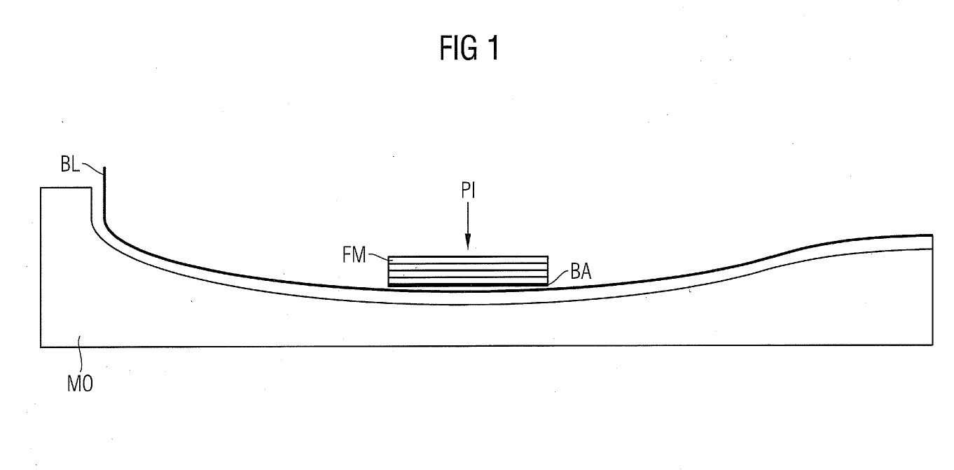

FIG. 1 shows a blade BL, which is manufactured according to the invention.

A predefined number of fiber-mats FM are stacked vertically as a pile PI to form a separate module for the blade-production.

A bottom layer of at least nearly airtight material is used as a basis BA for the pile PI. The pile PI is transported as described below into a mould MO, which is used to produce the blade in a sandwich-build-up.

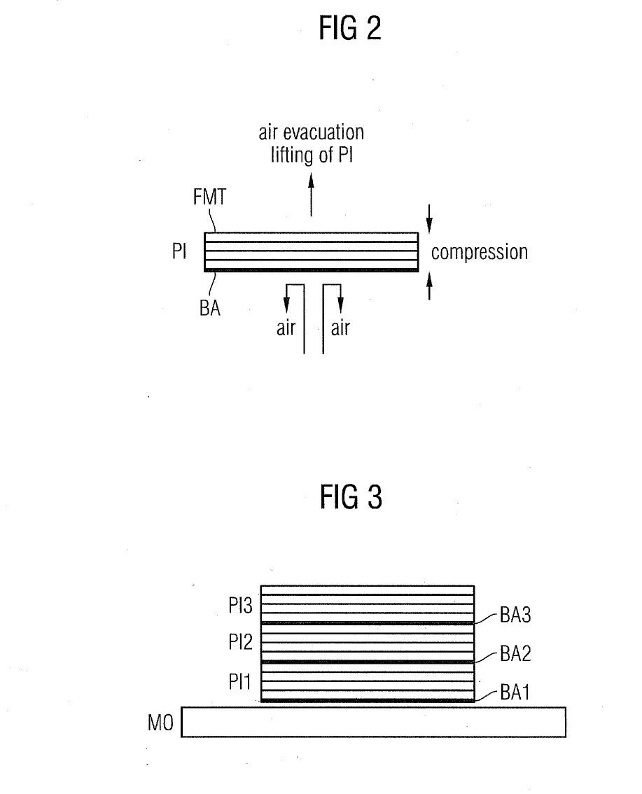

FIG. 2 and FIG. 3 show piles PI according to the invention in more detail.

To the pile PI an extraction of air is applied to a topmost fiber-mat FMT in a way that the pile PI is compressed vertically as the basis BA blocks surrounding air to flow vertically through the basis BA and through the pile PI.

So it is possible to lift up the pile PI vertically and to transport the pile PI together with its basis BA to be positioned into the mould MO of FIG. 1.

It is possible to use uncoated or coated paper as basis BA as this material is nearly airtight. It is also possible to use a plastic foil for this.

Referring now to FIG. 3 it is also possible to stack a number of piles PI1, PI2, PI3 vertically to be used for building up of the blade BL of FIG. 1, while the piles PI1 up to PI3 are separated by its basis BA1, BA2, BA3.

The basis BA1 of a first pile PI1 is destined to be located nearby the surface of the mould MO, so it is possible to use paper or plastic foil as basis BA1.

If plastic foil is used the foil has to be removed afterwards, as it does not bond with the resin, which is applied afterwards to the blade during the VARTM-process.

A second pile PI2, which is put on top of the first pile PI1, uses paper as its basis BA2. Paper bonds with the resin, so it is possible for the paper to stay inside the stacked piles.

1.-18. (canceled)

19. A method to produce a wind-turbine-blade, comprising
arranging a bottom layer into a forming tool, the bottom layer is a base of a pile which is made of a base material which prevents surrounding air from flowing vertically through the pile;
stacking a predefined number of additional layers vertically on top of the base to form the pile, which is used as a separate module for the production of the wind-turbine-blade; and
extracting air by a machine, which is applied to a topmost layer of the pile, such that the pile is sucked towards the machine, to allow the pile to be lifted up and to be moved into a mould for the further production of the wind-turbine-blade.

20. The method according to claim 19, wherein the layers comprises fiber-mats or plies of fiber-woven fabrics or plies of nonwoven fabrics or roving bundles or partially impregnated fibers or pre-impregnated layers of fiber or balsa wood or foam.

21. The method according to claim 19, wherein the layers are prefabricated in their size before they are piled.

22. The method according to claim 19, wherein the base material is paper.

23. The method according to claim 19, wherein the base material is a plastic foil.

24. The method according to claim 19, wherein the base material is a pre-impregnated layer of fiber material.

25. The method according to claim 19, wherein the extracting results in a technical vacuum inside the pile.

26. The method according to claim 19, further comprising mechanically compressing the pile before the air-extraction is applied in order to avoid a horizontally intrusion of surrounding air into the pile.

27. The method according to claim 19, wherein a plurality of piles are stacked vertically in the forming tool such that two adjacent piles are separated by a single base of one of the two adjacent piles.

28. The method according to claim 27, wherein the plurality of piles includes a bottom pile, which is nearest the surface of the mould, and the base material of the bottom pile is paper of a plastic foil.

29. The method according to claim 28, wherein the plurality of piles includes a second pile, which is arrange on top of the bottom pile, and the base material of the second pile is paper.

30. The method according to claim 19, wherein the pile is encased by paper such that the paper forms the base material and is also used as a box encase the pile.

31. An arrangement for the production of a wind-turbine-blade
a pile, which is a separate module for the production of the wind-turbine-blade, comprising:
a bottom layer as a base of the pile, the bottom layer is made of a base material effective to prevent surrounding air from flowing vertically through the pile;
a predefined number of additional layers are stacked vertically on top of the base;
a forming tool used to form the pile with the base inserted at the bottom of the forming tool; and
an air extraction machine, located nearby the forming tool, acts on a topmost layer of the pile to extract air from the pile so the pile is sucked towards the air extraction machine to lift the pile up in order to be brought into a mould for the further production of the wind-turbine-blade.

32. The arrangement according to claim 31, wherein the layers comprises fiber-mats or plies of fiber-woven fabrics or plies of nonwoven fabrics or roving bundles or partially impregnated fibers or pre-impregnated layers of fiber or balsa wood or foam.

33. The arrangement according to claim 31, wherein the layers are prefabricated in size before they are piled.

34. The arrangement according to claim 31, wherein the base material is paper, a plastic-foil or a pre-impregnated layer of fiber material.

35. The arrangement according to claim 31, wherein the forming tool comprises a plurality of vertically stacked piles such that two adjacent piles are separated by a single base of one of the two adjacent piles.

36. The arrangement according to claim 33, wherein the base material of a first pile, located nearby the surface of the mould, is made of paper or plastic foil.

37. The arrangement according to claim 36, wherein the base material of a second pile, arranged on top of the first pile, is made of paper.

38. The arrangement according to claim 31, wherein the pile is encased by paper such that the paper is used as the base material and is also used as a box to enclose the pile.
